(19) United States
(12) Patent Application Publication
(10) Pub. No.: US 2018/0316771 A1
(43) Pub. Date: Nov. 1, 2018

(54) METHOD AND APPARATUS FOR MONITORING USER ACTIVITY ASSOCIATED WITH A USER DEVICE

(71) Applicant: Vigilant Applications Ltd, Abingdon (GB)

(72) Inventor: Tom MEDHURST, Abingdon (GB)

(73) Assignee: Vigilant Applications Ltd, Abingdon (GB)

(21) Appl. No.: 15/497,696

(22) Filed: Apr. 26, 2017

(51) Int. Cl. H04L 29/08; H04L 12/26

(52) U.S. Cl. CPC H04L 67/22; G06F 21/602; H04L 43/028; H04L 43/04

(57) ABSTRACT

A method is provided in which an event is received from a user device accessibility service on a user device. The event is provided in response to the occurrence of an accessibility event. In response to the event, data which for example is displayed is obtained. The captured data may be transmitted to a monitoring service.

### FIELD

Some embodiments may relate to a method and apparatus which allow activities associated with a user device to be monitored.

### BACKGROUND

Mobile data management services are known which allow companies to monitor and record employee's voice calls on phones used for company business. This may be to ensure compliance with regulatory requirements or for training purposes.

However, not all conversations are conducted via voice calls.

### SUMMARY

According to an aspect there is provided a method comprising: receiving from an user device accessibility service on a user device an event, said event being provided in response to the occurrence of an accessibility event associated with the user device to user interaction with a user interface of said user device; obtaining in response to said event, data associated with the occurrence of said accessibility event; and causing output data to be transmitted from said user device to a monitoring server, said output data being dependent on one or more of said event and said associated data.

The accessibility event may be provided in response to user interaction with a user interface of said user device.

The accessibility event may be provided in response to data being received by said user device from a network, said data to be provided via said device to a user of said device

The data associated with the occurrence of said accessibility event may comprise data displayed on a display of said user device.

The data associated with the occurrence of said accessibility event may comprise data input to user device via said user interface.

The output data may comprises at least a part of said data associated with the occurrence of said accessibility event.

The data associated with the occurrence of said accessibility event may comprise data associated with an image displayed on said display.

The method may comprise filtering said events to select one or more events satisfying one or more criteria.

The method may comprise modifying a content of at least a part of said data associated with the occurrence of said accessibility event.

The method may comprise causing said modified data to be provided as said output data.

The modifying a content may comprise one or more of: removing at least part of said content; adding to said content; and replacing at least a part of said content.

The method may comprise storing at least a part of the data associated with the occurrence of said accessibility event.

The output data may comprises one or more of time information and location information.

The method may comprise encrypting data to provide said output data.

The method may comprise compressing data to provide said output data.

According to another aspect, there is provided a non-transitory computer readable storage device for storing instructions that, when executed by at least one processor, causes said at least one processor to: receive from a user device accessibility service on a user device an event, said event being provided in response to the occurrence of an accessibility event associated with the user device to user interaction with a user interface of said user device; obtain in response to said event, data associated with the occurrence of said accessibility event; and cause output data to be transmitted from said user device to a monitoring server, said output data being dependent on one or more of said event and said associated data.

According to another aspect, there is provided an apparatus comprising at least one processor and at least one memory including computer code for one or more programs, the at least one memory and the computer code configured, with the at least one processor, to cause the apparatus at least to: receive from a user device accessibility service on a user device an event, said event being provided in response to the occurrence of an accessibility event associated with the user device to user interaction with a user interface of said user device; obtain in response to said event, data associated with the occurrence of said accessibility event; and cause output data to be transmitted from said user device to a monitoring server, said output data being dependent on one or more of said event and said associated data.

The apparatus may be provided in a user device.

In the above, many different embodiments have been described. It should be appreciated that further embodiments may be provided by the combination of any two or more of the embodiments described above.

A computer program comprising program code adapted to perform the any of the previous methods may also be provided.

Various other aspects and further embodiments are also described in the following detailed description and in the attached claims.

### BRIEF DESCRIPTION OF DRAWINGS

Some embodiments will now be described by way of example only and with reference to the accompanying Figures in which:

FIG. 1 schematically shows a system in which some embodiments may be provided;

FIG. 2 schematically shows a user device;

FIG. 3 schematically shows functional blocks of the user device in some embodiments; and

FIG. 4 schematically shows a method of some embodiments.

### DETAILED DESCRIPTION

In some embodiments, user activity on a user device can be monitored and/or recorded. This may be for one or more reasons, such as security, compliance, training and dispute resolution purposes.

The user device may be any suitable device and may for example be a mobile endpoint device such as a phone, a tablet, laptop, portable computer or any other suitable device.

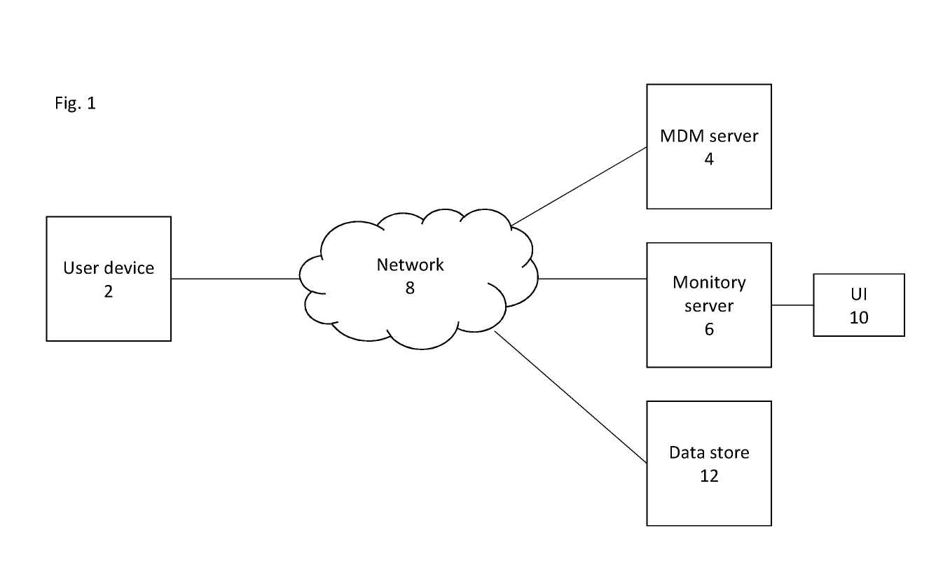

Reference is made to FIG. 1 which schematically shows a system in which some embodiments may be provided. The system comprises one or more user devices, only one of which is shown in FIG. 1. The one or more user devices are arranged to communicate with an MDM (mobile data management) server 4 and a monitor server 6 via a network.

The network may be any suitable network, public or private or a combination of the two. In some embodiments the network may be provided by the Internet. In some embodiments the network may be provided by a telecommunications network. The telecommunications network may be a wireless network and/or a wired network. In some embodiments, the telecommunications network may be a mobile telecommunications network.

The MDM provides a way of satisfying regulatory requirements and/or controlling the activities of employees on a company's user device. For example, the MDM may allow data segregation on the user device, email security and/or the like. MDM functions may comprise the providing of applications to a user device and/or data and configuration settings for the user device. The MDM functions may alternatively or additionally comprise ensuring that one or more applications are running on the user device. The MDM functions may alternatively or additionally comprise ensuring that one or more applications are installed on the device and are not removed.

In the described example, the MDM server and the monitor server are separate devices. In other embodiments, the MDM and monitoring functions are provided by the same server function.

The monitor server and/or the MDM server may be provided by one or more servers.

It should be appreciated that the user device can use any suitable access technology in order to access the network. By way of example, that access technology may be wireless technology such as wireless cellular telecommunications, WLAN (wireless local area network) or wired technology.

The monitor server may be arranged to store data received from the user devices in one or more data stores. The data store may be in the form of one or more databases.

A user interface 10 may be provided to allow a user to access the monitor server. This may for example to control the behaviour of one or more user devices and/or to define data and/or applications of interest. The user interface may also have a display which displays collected data and/or information about collected data.

In some embodiments, the MDM server and the monitor server may be in communication either via the network or via a more direct communication path.

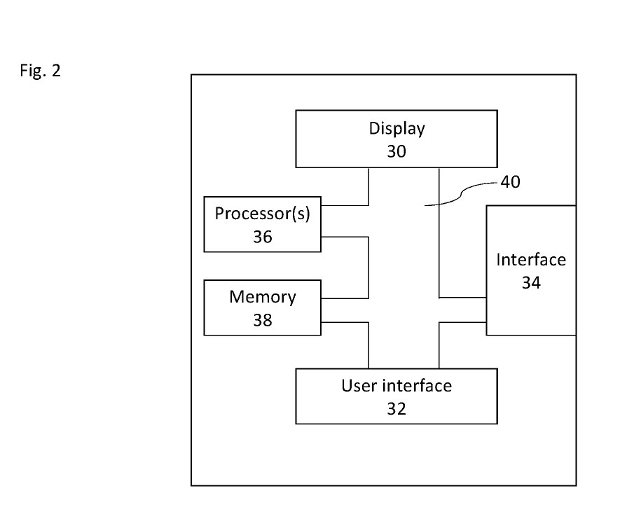

Reference is made to FIG. 2 which schematically shows an example user device 2. The user device 2 has a display and a user interface 32. The user interface may be provided by a keyboard and/or a touch screen and/or any other suitable user interface. In some embodiments the display may be provided by a touch screen. In some embodiments a touch screen may provide a display function and a user interface function.

The device has an interface 34 which is configured to provide the device with access to the network, which may be the Internet as described previously. In some embodiments, the interface may be an interface to a wireless network such as mobile network or a WLAN (wireless local area network) and/or to a wired network.

The device will have a control part 37 which comprises one or more processors 36 and one or more memories 38. The control part 37 may provide graphics control and sound control. For example, the control part may provide an output to provide the image displayed by the display. The device may provide an audio output which is provided by the control part.

The device may have a GPS module 39 or similar configured to provide location information. This is optional is some embodiments.

The user device has an interconnect or bus 40 which allows communication between the different parts of the device.

It should be appreciated that in some embodiments, the control part 37 at least may be implemented by one or more integrated circuits, at least in part.

Some user device platforms or operating systems provide interfaces that allow for the development of accessibility services that provide alternative or augmented feedback to the user. Such APIs were designed for individuals with impaired visual, auditory or motor function. For example, the Android operating system provides such accessibility services.

User devices built with these operating systems are also capable of being constrained by MDM software which can prohibit or enforce the use of specific applications on that device.

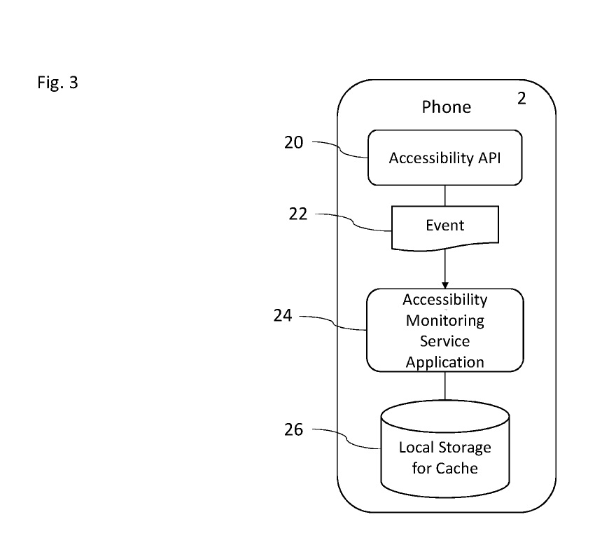

Reference is made to FIG. 3 which shows the functional blocks on the user device in some embodiments. An accessibility API (application programming interface) 20 which provides an API to an accessibility monitoring service. The API will provide detected events schematically represented in FIG. 3 by reference numeral 22. The events are detected by the accessibility service. The event is provided to an accessibility monitoring service application 24. Data which is collected and/or manipulated may be stored in local storage 26. This will be described in more detail.

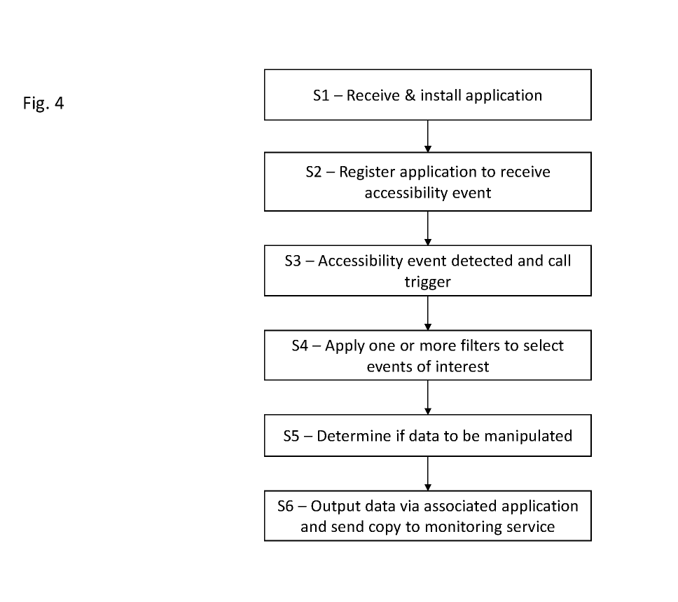

Reference is made to FIG. 4 which shows a method of an embodiment.

In step S1, the user device receives and installs the accessibility monitoring service application for monitoring user activity on the user device. This may be received from the MDM server in some embodiments. In other embodiments, this application may be received from the monitor server. The accessibility monitoring service application may be pushed to the user device from the MDM server or the monitor server.

The accessibility monitoring service application may define one or more application or application types the accessibility monitoring service is to provide associated events.

In step S2, the accessibility monitoring service application is registered on the user device to receive accessibility events which are detected by the accessibility service.

In some embodiments, the accessibility monitoring service application will register to receive all of the events detected by the accessibility service

In other embodiments, the accessibility monitoring service application will set the configuration variables or options for the accessibility service. This may be for the service generally or the service as so far as the accessibility monitoring service application is concerned. These configuration variables or options will define what event types the accessibility monitoring service should respond to. For example, the accessibility monitoring service will be set to monitor any interaction with the user interface by the user. This may be to detect the input of text via a keyboard or touch screen, selection of one or more options, selection of a particular application or the like. In some embodiments, the interaction with the user interface by the user may comprise an audio input from the user.

The accessibility monitoring service may be set to monitor for external triggers. These external triggers may be the receipt of messages for the user, for example via a messaging application. In some embodiments the accessibility monitoring service may be configured to monitor for events which are associated with data which is to be presented to the user, for example via the display and/or via an audio output. The accessibility monitoring service is not by in large monitoring for control data relating to the control of the device.

In step S3, an accessibility event is detected by the accessibility service. This will be an event which the accessibility monitoring service application has registered to receive.

In step S4, one or more filters may be applied to select the events of interest and a call is triggered. For example, each subsequent change in the user interface will trigger a call (event) to that service. The call to the service will be to obtain the content which triggered the event and optionally any associated label. In some embodiments, an event may be associated with a label. This label may be used to determine if the event is an event of interest. The content which is obtained may be data which is displayed on the device as a result of user interaction with the device or the receipt of data from an external source. The data from an external source may for example be messaging data.

In some embodiments, the filtering may be optional if the accessibility monitoring service application has registered to only receive a subset of events.

For each event generated, the accessibility monitoring service application on the mobile device may do one or more of the following:
filter events of interest from particular applications—for example, from messaging clients or applications;
identify data of interest, for example messages from instant messaging, chat or similar applications, text typed by the user for output, images sent into the device, and/or the like;
record the information from a particular application locally on the device to be accessed for further manipulation. This may provide a record of a conversation or transaction independent of any function the originating application might or might not have for saving such data; and
compress and/or encrypt the data of interest

In step S5, it is determined if the data is to be manipulated.

For example, the data in question may be altered or manipulated in one or more of the following ways:
re-write and/or remove commercially sensitive or inappropriate text;
prohibit actions which have been deemed inappropriate in relation to a previously defined policy;
prohibit actions which are anomalous;
prohibit actions which are deemed unusual
prohibit actions which are not in a set of allowed actions; and
prohibit actions which would potentially remove the service (such as accessing system settings or other accessibility controls).

In step S6, output data associated with a particular application is output. This output data is optionally transmitted to the monitor server. The output data may comprise a copy of at least part of the data or some function associated with respective event. For example, the output data may be part or all of a captured screen associated with the respective event. In another example, the output data may be information about user interaction with the user interface. The output data may comprise summary data, for example an indication of an active application or an indication of who the user of the user device is in communication with. The output data which is sent may be sent with one or more additional data such as time information, for example a time stamp and/or geographic location of the user device (for example provided by the GPS or other location module) and/or setting information. The setting information may be one or more network setting and/or one or more user device configuration setting. This may be used for discrepancy detection, for example. For example the IP address or location information may be used to determine if there is a discrepancy between the current location of a user and his reported location. Another example is where there is a discrepancy about user device availability due to battery life reported by a user and actual battery life provided by the setting information.

The monitoring service may then do one or more of the following with the data received for the user device:
perform data-manipulation and/or normalization operations such as transcription, translation, character recognition;
persist the data into a long-term storage archive, for example for storing a compliant record of financial transactions/agreements;
alert on actions which are deemed worthy of attention according to pre-configured policies; and
apply algorithms or analysis to identify anomalous or irregular actions.

One or more steps of FIG. 4 may be performed by an apparatus of the user device. The apparatus may be provided by one or more data processors. The data processors may be of any type suitable, and may include one or more of microprocessors, digital signal processors (DSPs), application specific integrated circuits (ASIC), gate level circuits and processors based on multi core processor architecture, as non-limiting examples. The data processing may be distributed across several data processing modules. A data processor may be provided by means of, for example, at least one chip. Appropriate memory capacity can also be provided in the relevant devices. The memory or memories may be of any type suitable to the local technical environment and may be implemented using any suitable data storage technology, such as semiconductor based memory devices, magnetic memory devices and systems, optical memory devices and systems, fixed memory and removable memory.

In general, the various embodiments may be implemented in hardware or special purpose circuits, software, logic or any combination thereof. Some aspects of may be implemented in hardware, while other aspects may be implemented in firmware or software which may be executed by a data processor or the like. The software may be stored on such physical media as memory chips, or memory blocks implemented within the processor, magnetic media such as hard disk or floppy disks, and optical media such as for example DVD and the data variants thereof, CD.

Some embodiments may be provided by a computer program running on the at least one processor. The computer program may comprise computer implemented instructions which are stored in the at least one memory and which may be run on the at least one processor. A computer program product may be provided which comprises computer program product comprising code embodied on a computer-readable medium which is configured to be executed on a processor of the computer or user device. In some embodiments, a non-transitory computer readable storage device may be provided to store program code instructions that, when executed by at least one processor causes any of the above described methods to be performed.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

We claim:

1. A method comprising:
receiving from a user device accessibility service on a user device an event, said event being provided in response to the occurrence of an accessibility event associated with the user device to user interaction with a user interface of said user device;
obtaining in response to said event, data associated with the occurrence of said accessibility event; and
causing output data to be transmitted from said user device to a monitoring server, said output data being dependent on one or more of said event and said associated data.

2. A method as claimed in claim 1, wherein said accessibility event is provided in response to user interaction with a user interface of said user device.

3. A method as claimed in claim 1, wherein said accessibility event is provided in response to data being received by said user device from a network, said data to be provided via said device to a user of said device

4. A method as claimed in claim 1, wherein said data associated with the occurrence of said accessibility event comprises data displayed on a display of said user device.

5. A method as claimed in claim 1, wherein said data associated with the occurrence of said accessibility event comprises data input to user device via said user interface.

6. A method as claimed in claim 1, wherein said output data comprises at least a part of said data associated with the occurrence of said accessibility event.

7. A method as claimed in claim 1, wherein said data associated with the occurrence of said accessibility event comprises data associated with an image displayed on said display.

8. A method as claimed in claim 1, comprising filtering said events to select one or more events satisfying one or more criteria.

9. A method as claimed in claim 1, comprising modifying a content of at least a part of said data associated with the occurrence of said accessibility event.

10. A method as claimed in claim 9, comprising causing said modified data to be provided as said output data.

11. A method as claimed in claim 9, wherein said modifying a content comprises one or more of: removing at least part of said content; adding to said content; and replacing at least a part of said content.

12. A method as claimed in claim 1, comprising storing at least a part of the data associated with the occurrence of said accessibility event.

13. A method as claimed in claim 1, wherein output data comprises one or more of time information and location information.

14. A method as claimed in claim 1, comprising encrypting data to provide said output data.

15. A method as claimed in claim 1, comprising compressing data to provide said output data.

16. A non-transitory computer readable storage device for storing instructions that, when executed by at least one processor, causes said at least one processor to:
receive from a user device accessibility service on a user device an event, said event being provided in response to the occurrence of an accessibility event associated with the user device to user interaction with a user interface of said user device;
obtain in response to said event, data associated with the occurrence of said accessibility event; and
cause output data to be transmitted from said user device to a monitoring server, said output data being dependent on one or more of said event and said associated data.

17. An apparatus comprising at least one processor and at least one memory including computer code for one or more programs, the at least one memory and the computer code configured, with the at least one processor, to cause the apparatus at least to:
receive from a user device accessibility service on a user device an event, said event being provided in response to the occurrence of an accessibility event associated with the user device to user interaction with a user interface of said user device;
obtain in response to said event, data associated with the occurrence of said accessibility event; and
cause output data to be transmitted from said user device to a monitoring server, said output data being dependent on one or more of said event and said associated data.
